(19) United States
(12) Patent Application Publication
(10) Pub. No.: US 2001/0016104 A1
(43) Pub. Date: Aug. 23, 2001

(54) Plastic optical fiber cable and method of manufacturing the same

(75) Inventors: Naoshi Serizawa, Shizuoka (JP); Tsuyoshi Oshima, Shizuoka (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Yazaki Corporation, Tokyo, Corporation

(21) Appl. No.: 09/785,427

(22) Filed: Feb. 20, 2001

(30) Foreign Application Priority Data
Feb. 23, 2000 (JP) 2000-045531

(51) Int. Cl. G02B 6/16

(52) U.S. Cl. 385/128

(57) ABSTRACT

A plastic optical fiber cable 21 comprises a lead portion 22 of synthetic resin; and a coating portion 23 of synthetic resin. The coating portion comprises a core 24, a cladding 25 surrounding the core and a protective sheathing 26. The protective sheathing serves to protect said cladding from an effect when said coating portion is removed. The protective sheathing is harder than said cladding and has higher adherence to adhesive than said cladding has. Said protective sheathing has a thickness which is larger than a manufacturing clearance of said lead portion. In this configuration, a plastic optical fiber cable is provided which is not affected by removal of the coating portion.

### BACKGROUND OF THE INVENTION

1. Field of the Invention

This invention relates to a plastic optical fiber cable which is used as a communication medium and a method of manufacturing it.

2. Description of the Related Art

A technique of optical communication can transmit a large capacity of data and does not suffer from electromagnetic noise. For this reason, an optical fiber cable has been widely used as a communication medium. The optical fiber cable can be classified into a glass optical fiber cable and a plastic optical fiber cable which can be suitably used according to various uses.

As seen from FIG. 6, the plastic optical fiber cable 1 generally includes a lead portion 4 consisting of a core 2 and a cladding 3 both of which are made of synthetic resin and a coating portion 5 of synthetic resin which is kept in intimate contact with the outer periphery of the lead portion 4 which is also referred to as plastic optical fiber cord or coated plastic fiber. Such a plastic optical fiber cable 1 can be manufactured at lower cost than and is more excellent in flexibility than the glass optical fiber cable. For this reason, the plastic optical fiber cable 1 has been used a lot as a short-distance optical communication wiring between appliances which execute transmission/reception for optical communication.

Meanwhile, where the plastic optical cable 1 is used between the above appliances, it is necessary to remove the coating portion 5 of the plastic optical fiber cable 1 at its end. The removal is carried out in such a manner that removal blades 6, 6 are moved toward the center axis of the plastic optical fiber cable 1 (arrow P) to make cuts into the coating portion 5. Thereafter, the removal blades 6, 6 are moved back slightly in the arrow P. Next, the blades 6, 6 are moved in an arrow Q to remove the unnecessary portion of the coating portion 5. Thus, the removal of the coating portion 5 is completed.

After the coating portion at the end of the plastic optical fiber cable 1 has been removed, as shown in FIG. 7, adhesive is applied on the entire surface of the plastic optical fiber cable. A ferule 8 of metal or synthetic resin is fixed onto the surface of the fiber cable 1. At this time, the lead portion 4 protrudes from the front end of the cladding 5 at the front portion of the ferule 8. The protruding lead portion 4, after it has been cut and polished, is coupled with an optical element of the above appliance.

In most cases using the plastic optical fiber cable 1, for example, the core 2 is made of PMMA (polymethyl methacrylate), the cladding 3 is made of fluoroplastics and the coating portion 5 is made of polyamide resin. Therefore, when the coating portion of the plastic optical fiber cable 1 is removed at its end, numerous exfoliating marks are generated on the exposed surface of the cladding 3. This is probably because since the coating portion 5 of the synthetic resin has a higher melting point than that of the cladding 3, when the coating portion 5 is formed on the lead portion 4, the boundary therebetween suffers heat. The presence of the exfoliating traces 9 increases the possibility that the light which essentially makes total internal reflection at the boundary of the cladding 3 passes through the boundary as it is like arrow R. This increases the optical loss, thus adversely affecting the optical communication. Particularly, where the plastic optical fiber cable is used for the wiring for a short distance optical communication, the adverse effect may be serious.

In relation to the above problem, if the removing blade 6 cuts deep into the cladding 3 when the coating portion of the optical fiber cable 1 is removed at the end, a cutting trace 10 is generated. This increases possibility that the light does not make total internal reflection and passes through the boundary as it is like the case described above. The light passing through the cladding 3 interrupted by the cutting trace 10 of the removing blade 6. Therefore, the cutting trace 10 adversely affects the optical communication. Particularly, where the plastic optical fiber cable is used for the wiring for a short distance optical communication, the effect may be serious.

Incidentally, if the cutting trace 10 reaches the core 2, the optical communication is not only affected more greatly by the trace but break of the core 4 is feared.

Meanwhile, the ferule 8 is fixed on the front end of the optical fiber cable 1 by the adhesive 7. In this case, when the ferule, e.g. coupled between the appliances described above is exposed in an environment at a high temperature for a long time, the stress at the lead portion 4 which has been generated during manufacture and remains may exceed the fixing force of the adhesive 7, thereby generating fixing of the lead portion 4. Thus, the tip surface 11 of the core 4 retreats from the tip surface T of the ferule 8 as indicated by arrow S in FIG. 7. This will increase the optical loss due to the gap between the ferule and the optical appliance.

Still another problem is that because the cladding 3 is made of fluoroplastics, the adhesive 7 is difficult to adhere, thereby providing insufficient fixing force. A further problem is that when the tip surface T of the ferule 8 is finished by polishing, the cladding 3 may flow under the adverse effect of heat. A further problem is that when the redundant lead portion 4 protruding from the ferule 8 is cut into certain segments each having a certain length prior to polishing, the segment to be cut finally may remain as thin skin. If the remaining segment is torn off, the cladding 3 will be-easily damaged (As the case may be, this adversely affects the optical communication).

This invention has been accomplished under the above circumstance.

### SUMMMARY OF THE INVENTION

An object of this invention is to provide a plastic optical fiber cable in which optical communication is not affected by coating removal, and a method of manufacturing it.

Another object of this invention is to provide a plastic optical fiber cable with improved adherence to adhesive and capable of sufficiently displaying the function of a cladding.

In order to attain the above object, in accordance with this invention, there is provided a plastic optical fiber cable comprising:

a lead portion of synthetic resin; and

a coating portion of synthetic resin,

wherein the coating portion comprises a core, a cladding surrounding the core and a protective sheathing for protecting the cladding from an adverse effect when the coating portion is removed.

In this configuration, since the protective sheathing protects the cladding from an adverse effect when the coating portion is removed, a peeling or removing trace does not occur. The cutting trace by a removal blade does not also occur. Therefore, the optical communication is not adversely affected by the removal of the coating portion. The cladding can also display its function sufficiently.

The protective sheathing serves to protect the cladding from the adverse effect by the removal of the coating portion. Therefore, the cladding may consist of a single layer or plural layers. The plastic optical fiber cable may be a step index type (SI type) or a grated index type (GI type).

In the plastic optical fiber cable, preferably, the protective sheathing is harder than the cladding. In this case, the cladding can be also protected from the adverse effect other than removal of the coating portion. Specifically, even when the lead portion is cut by a single blade after the ferule has been fixed, the cladding does not remain as a skin. Since the protective sheathing is harder than the cladding, it can be easily cut. Since the cladding is located between the protective sheathing and the core, the effect of heat when the ferule is fixed and polished can be minimized.

In the plastic optical fiber cable, preferably the protective sheathing has higher adherence to adhesive than the cladding has. Therefore, the ferule can be surely fixed to the core portion, thereby improving the workability. Inexpensive adhesive can be used for the protective sheathing.

In the plastic optical fiber cable, preferably, the protective sheathing has a thickness which is larger than a manufacturing clearance of the lead portion. Because of this configuration, even if a removing blade cuts deep into the protective sheathing, a cutting trace does not reach the cladding. In other words, the protective sheathing protects the cladding from the adverse effect by the removal of the coating portion. Therefore, the cladding can sufficiently realize its function.

In accordance with this invention, there is provided a method of manufacturing a plastic optical fiber cable, comprising the steps:

a lead-portion making step of making a coating portion made of synthetic resin and including a core and a cladding surrounding the core; and

a coating-portion making step of making a coating portion made of synthetic resin and kept in contact with the lead portion,

wherein the lead-portion making step includes a step of making a protective sheathing for protecting the cladding from an adverse effect when the coating portion is removed.

In the plastic optical fiber cable manufactured according to the above manufacturing method, since the protective sheathing protects the cladding from an adverse effect when the coating portion is removed, a removal trace does not occur. The cutting trace by a removal blade does not also occur. Therefore, the optical communication is not affected by the removal of the coating portion. The cladding can also display its function sufficiently.

In the step of making the protective sheathing of the above manufacturing method, it is made using a material which is harder than the cladding. The cladding of the plastic optical fiber cable thus manufactured can be also protected from the effect other than removal of the coating portion. Specifically, even when the lead portion is cut by a single blade after the ferule has been fixed, the cladding does not remain as a skin. Since the protective sheathing is harder than the cladding, it can be easily cut. Since the cladding is located between the protective sheathing and the core, the effect of heat when the ferule is fixed and polished can be minimized.

In the step of making the protective sheathing in the above manufacturing method, preferably, it is made using a material which has higher adherence to adhesive than the cladding has. Therefore, the ferule can be surely fixed to the core portion, thereby improving the workability. Inexpensive adhesive can be used for the protective sheathing.

In the step of making the protective sheathing in the above manufacturing method, it is made so as to have a thickness which is larger than a manufacturing clearance of the lead portion. Therefore, even if a removing blade cuts deep into the protective sheathing, a cutting trace does not reach the cladding. In other words, the protective sheathing protects the cladding from the adverse effect by the removal of the coating portion. Therefore, the cladding can sufficiently realize its function.

The above and other objects and features of this invention will be more apparent from the following description taken in conjunction with the accompanying drawings.

### BRIEF DESCRIPTION OF THE DRAWINGS

FIG. 1 is a sectional view of an embodiment of the plastic optical fiber cable according to this invention;

FIG. 2 is a sectional view showing the state is coating removal of the plastic optical fiber cable according to this invention;

FIG. 3 is a sectional view showing the state of the plastic optical fiber cable when a ferule is fixed;

FIG. 4 is a schematic block diagram for explaining a method of manufacturing a plastic fiber cable according to this invention;

FIG. 5 is a sectional view of a plastic optical fiber cable with two poles of cores;

FIG. 6 is a sectional view showing the state in coating removal of a conventional plastic optical fiber cable; and

FIG. 7 is a sectional view showing the state of the conventional plastic optical fiber cable when a ferule is fixed.

### DESCRIPTION OF THE PREFERRED EMBODIMENTS

Now referring to the drawings, an explanation will be given of an embodiment of this invention.

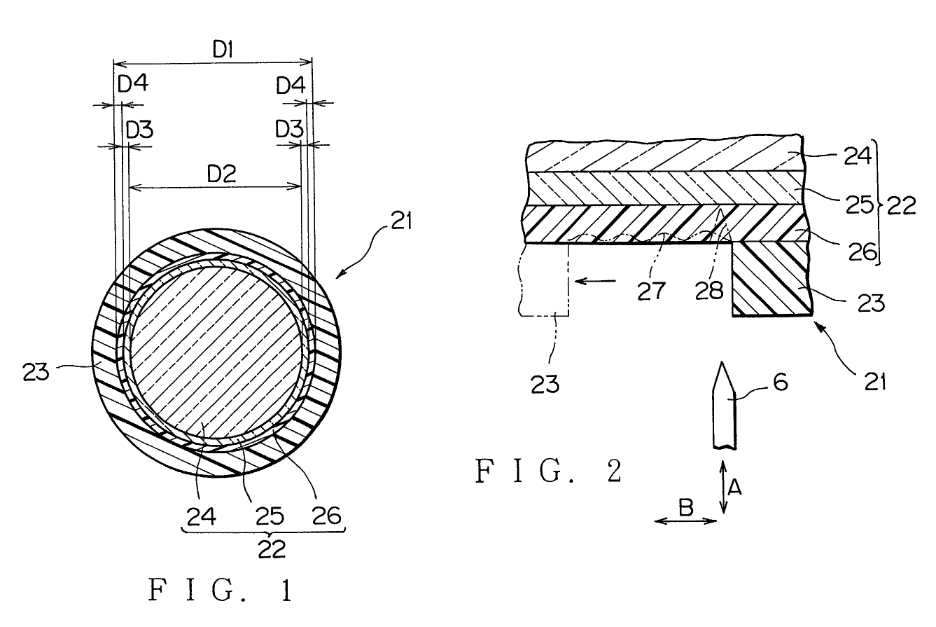

FIG. 1 is a sectional view of an embodiment of the plastic optical fiber cable according to this invention.

In FIG. 1, a plastic optical fiber cable 21 includes a lead portion 22 of synthetic resin and a coating portion 23 of synthetic resin kept in intimate contact with the outer periphery thereof. The lead portion 22 includes a core 24, a cladding 25 and a protective sheathing 26. The protective sheathing 26 is adapted to protect the cladding 25 from the adverse effect when the coating portion 23 is removed. A plastic fiber cable 21 according to this embodiment was manufactured so that the lead portion 22 has a diameter D1 of 1000 μm and a manufacturing clearance is ±5 μm.

The core 24 has a diameter of D2 of 960 μm and is made of PMMA (polymethyl methacrylate) in view of an optical performance, mechanical strength and reliability. The core may be made of polycarbonate (PC).

The cladding 25 has a thickness D3 of 10 μm and is made of fluoroplastics. The cladding 25 may be made of α-fluoroacrylate copolymer. The cladding 25, which was constructed as a single layer in this embodiment, may be formed as plural layers.

The protective sheathing 26 is located outside the cladding 25, and has a thickness D4 of 10 μm. The thickness D4 is preferably not smaller than the manufacturing clearance. In this embodiment, the thickness D4 may be not smaller than (The upper limit thereof is 20 μm in view of the occupying rate to the diameter D1 of the lead portion 22).

The protective sheathing 26 is provided in order to protect the cladding 25 from the adverse effect when the coating portion 23 is removed. The protective sheathing 26 may not have a refractive index lower than that of the cladding 25. The protective sheathing 26 may not be transparent (is preferably not light-absorptive).

The protective sheathing 26 is made of the material which has greater hardness and adherence than that of the cladding 25.

The protective sheathing 26 is preferably made of PMMA (polymethyl methacrylate), PS (polystyrene), PET (polyethylene terephthalate), or PC (polycarbonate).

The coating portion 23 is a member for protecting the lead portion 22, and is made of polyamide (PA (e.g. nylon 12)), polyethylene (PE) or polyvinyl chloride (PVC). The coating portion 23, which was constructed as a single layer in this embodiment, may be formed as plural layers.

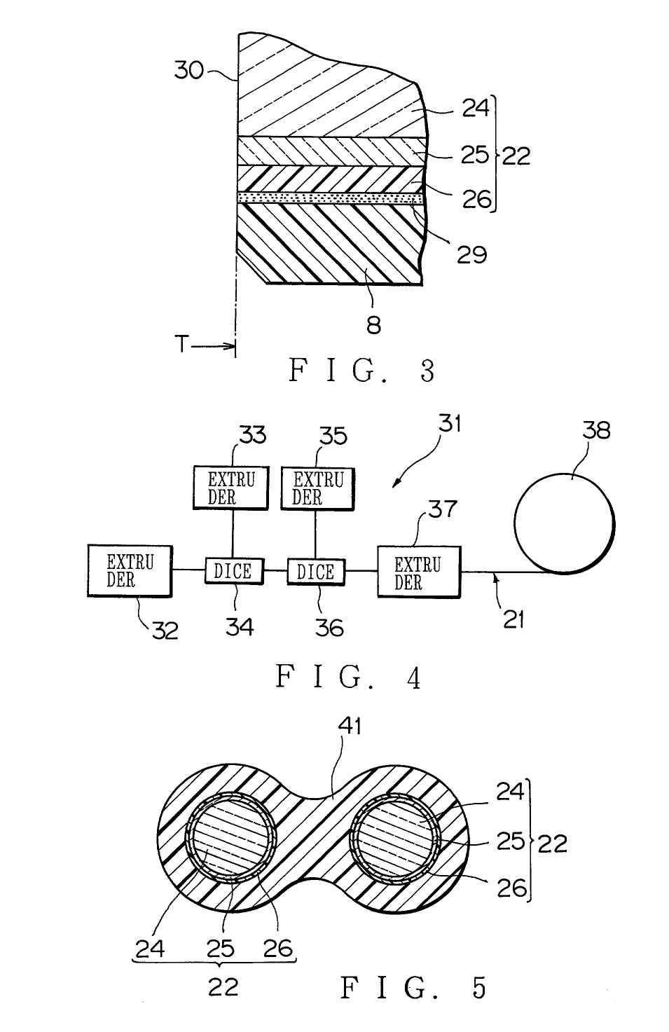

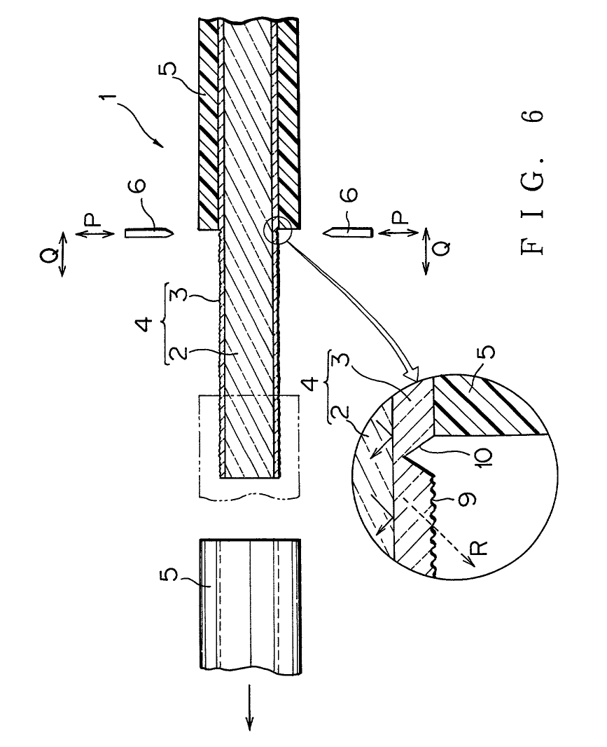

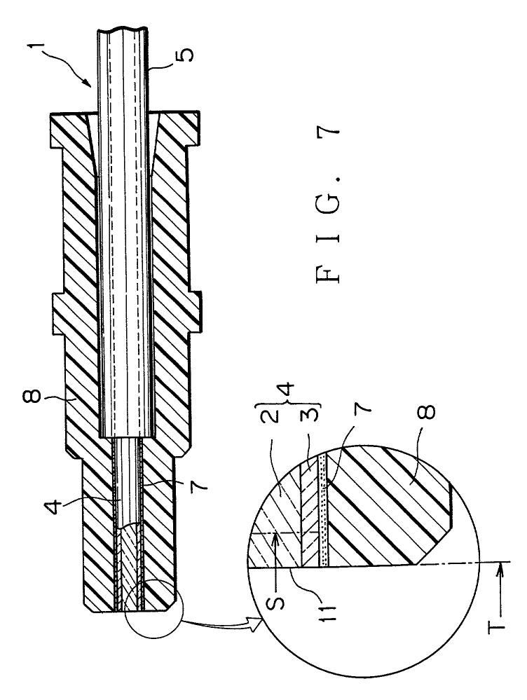

In the plastic optical fiber cable having the configuration described above, as seen from FIG. 2, when coating removing blades 6, 6 (only one is shown) is moved in arrow A or arrow B to remove the coating portion 23, a removal trace 27 may appear on the surface of the protective sheathing 26 as in the prior art, but this does not entirely affect the cladding 25. Further, even if the removing blades 6, 6 (only one is shown) cuts deep into the protective sheathing 26, a cutting trace 28 does not reach the cladding 25. In other words, the protective sheathing 26 protects the cladding 25 from the adverse effect by the removal of the coating portion 23. Therefore, the cladding 25 can sufficiently realize its function.

Thus, as shown in FIG. 3, a ferule 8 can be firmly fixed to the lead portion 22. Specifically, adherence of adhesive 29 to the protective sheathing 26 is great so that the protective sheathing 26 improves the fixing force between the ferule 8 and the lead portion 22. Even when the residual stress for the plastic optical fiber cable 21 is relaxed in a severe environment, the tip surface of the lead portion 22 remains aligned with the tip surface T of the ferule 8.

Since the protective sheathing 26 is harder than the cladding 25, the cladding 25 can be also protected from the adverse effect other than removal of the coating portion 23. Specifically, even when the lead portion 22 is cut by a single blade after the ferule 8 has been fixed, the cladding 25 does not remain as a skin. Since the protective sheathing 26 is harder than the cladding 25, it can be easily cut.

Since the cladding 25 is located between the protective sheathing 26 and the core 24, the effect of heat when the ferule 8 is fixed and polished can be minimized.

Referring to FIG. 4, an explanation will be given of a method of manufacturing a plastic optical fiber cable 21. FIG. 4 is a block diagram of an embodiment of an apparatus for manufacturing the plastic optical fiber cable according to this invention.

In FIG. 4, the plastic optical fiber cable 21 is manufactured by a manufacturing apparatus 31. First, a core material is extruded by an extruder 32 while a cladding material is extruded by an extruder 33. Thus, the core material and the cladding material are unified in a dice 34 so that the cladding material surrounds the outer periphery of the core material. The unified material is extruded from the outlet of the dice 34 and unified with a protective sheathing material in a dice 36 so that the protective sheathing surrounds the cladding material. The protective sheathing material is extruded from an extruder 35 (step of forming the protective sheathing). The process to this step is referred to as a lead portion forming step. A coating portion is formed on the workpiece thus unified by an extruder 37. This step is referred to as the coating portion forming step. The plastic optical fiber cable 21 is taken up by a take-up machine 38.

In the step of forming the protective sheathing, the above material and other conditions are set.

Since the lead portion manufacturing step includes the step of forming the protective sheathing, a coating portion 42 can be kept in intimate contact with lead portions 22, 22 (each having the structure as shown in FIG. 1) arranged with two poles as shown in FIG. 5. The coating portion 41 can be formed to extend over the lead portions with two poles. This is a manufacturing method which is suitable to manufacture a tape-like optical fiber cable.

The manufacturing apparatus 31 shown in FIG. 4 can be divided into two apparatus which separately carry out the lead portion manufacturing step and the coating portion manufacturing step. After the unified structure of the core and cladding has been formed to complete the step of manufacturing the lead portion, prior to providing the coating portion, the protective sheathing may be provided on the cladding in the step of manufacturing the coating portion.

In summary, the method of manufacturing the plastic optical fiber cable 21 according to this invention includes a step of manufacturing a lead portion inclusive of forming a protective sheathing and a step of manufacturing a coating portion. Therefore, this method can manufacture a plastic optical fiber cable comprising a lead portion 22 including a core 24, a cladding 25 and a protective sheathing 26 and a coating portion 23 in contact with the lead portion 22 (see FIG. 1).

It is needless to say that this invention can be realized in various modifications.

The plastic optical fiber cable 21 may be a step index type (SI type) or a grated index type (GI type).

What is claimed is:

1. A plastic optical fiber cable comprising:
a lead portion of synthetic resin; and
a coating portion of synthetic resin,
wherein said coating portion comprises a core, a cladding surrounding the core and a protective sheathing for protecting said cladding from an adverse effect when said coating portion is removed.

2. A plastic optical fiber cable according to claim 1, wherein said protective sheathing is harder than said cladding.

3. A plastic optical fiber cable according to claim 1, wherein said protective sheathing has higher adherence to adhesive than said cladding has.

4. A plastic optical fiber cable according to claim 1, wherein said protective sheathing has a thickness which is larger than a manufacturing clearance of said lead portion.

5. A method of manufacturing a plastic optical fiber cable, comprising the steps:
a lead-portion making step of making a coating portion made of synthetic resin and including a core and a cladding surrounding the core; and
a coating-portion making step of making a coating portion made of synthetic resin and kept in contact with said lead portion,
wherein said lead-portion making step includes a step of making a protective sheathing for protecting said cladding from an adverse effect when said coating portion is removed.

6. A method of manufacturing a plastic optical fiber cable according to claim 5, wherein in said step of making the protective sheathing, it is made using a material which is harder than said cladding.

7. A method of manufacturing a plastic optical fiber cable according to claim 5, wherein in said step of making the protective sheathing, it is made using a material which has higher adherence to adhesive than said cladding has.

8. A plastic optical fiber cable according to claim 5, wherein in said step of making the protective sheathing, it is made so as to have a thickness which is larger than a manufacturing clearance of said lead portion.
